(19) United States
(12) Patent Application Publication
(10) Pub. No.: US 2019/0299856 A1
(43) Pub. Date: Oct. 3, 2019

(54) Digital Rear-View Mirror

(71) Applicant: Martin Wulfe, Silver Spring, MD (US)

(72) Inventor: Martin Wulfe, Silver Spring, MD (US)

(21) Appl. No.: 15/942,573

(22) Filed: Apr. 2, 2018

(51) Int. Cl. B60R 1/00; B60R 11/04

(52) U.S. Cl. CPC B60R 1/00; B60R 11/04; B60R 2300/303; B60R 2300/105; B60R 2300/802

(57) ABSTRACT

The Digital Rear-View Mirror replaces all mirrors currently used on automobiles and trucks. The driver sees an approximately 4″ high integrated digital screen, mounted on either the top or bottom of the front windshield, covering the full width of the windshield. The screen integrates images from at least 3 digital cameras, 2 from the sides and one from the rear of the vehicle, to form a continuous image covering 180 degrees, both sides and the rear of the vehicle. The screen's transparency can be adjusted automatically based on the amount of sunshine, or manually by the driver. The Digital Rear-View Mirror is active whenever the engine is running.

### CROSS-REFERENCE TO RELATED APPLICATIONS:

Not Applicable

### STATEMENT REGARDING FEDERALLY SPONSORED RESEARCH OR DEVELOPMENT (IF APPLICABLE):

Not Applicable

### BACKGROUND OF THE INVENTION:

The Digital Rear-View Mirror is designed to address shortcomings in visibility currently associated with physical mirrors used by automobiles and trucks by combining readily available digital technologies. Current techniques require drivers to divert their attention away from the road ahead of them, and still includes blind spots that are only partly resolved through other technologies. The result is 3 separate mirrors at different heights, and backup cameras that are only available when in reverse.

The solution presented by the Digital Rear-View Mirror is use up-to-date digital camera and display technology to provide drivers with a single location in the vehicle where they can view their surroundings on both sides and behind them while maintaining their attention on the road ahead.

### BRIEF SUMMARY OF THE INVENTION:

The Digital Rear-View Mirror replaces all mirrors currently used on automobiles and trucks. The driver sees an approximately 4″ high integrated digital screen, mounted on either the top or bottom of the front windshield, covering the full width of the windshield. The screen integrates images from at least 3 digital cameras, 2 from the sides and one from the rear of the vehicle, to form a continuous image covering 180 degrees, both sides and the rear of the vehicle.

The screen's transparency can be adjusted automatically based on the amount of sunshine, or manually by the driver. The Digital Rear-View Mirror is active whenever the engine is running.

### SEQUENCE LISTING:

Not Applicable

### BRIEF DESCRIPTION OF THE SEVERAL VIEWS OF THE DRAWING:

FIG. 1: Interior view showing installation location (1) of Digital Rear-View Mirror at bottom edge of windshield (not to scale)

This is a line drawing of the placement of the Digital Rear-View Mirror (1) when positioned at the bottom of the windshield when viewed from the interior of an automobile.

FIG. 2: Interior view showing installation location (2) of Digital Rear-View Mirror at top edge of windshield (not to scale)

This is a line drawing of the placement of the Digital Rear-View Mirror (2) when positioned at the bottom of the windshield when viewed from the interior of an automobile.

FIG. 3: Exterior top view showing approximate location of side cameras (3 and 4) and rear camera (5) (not to scale)

This is a line drawing showing the top view of an automobile with the approximate locations of side cameras (3 and 4) and rear camera (5).

FIG. 4A and 4B: Exterior left and right side views showing approximate location of side cameras (3 and 4) (not to scale)

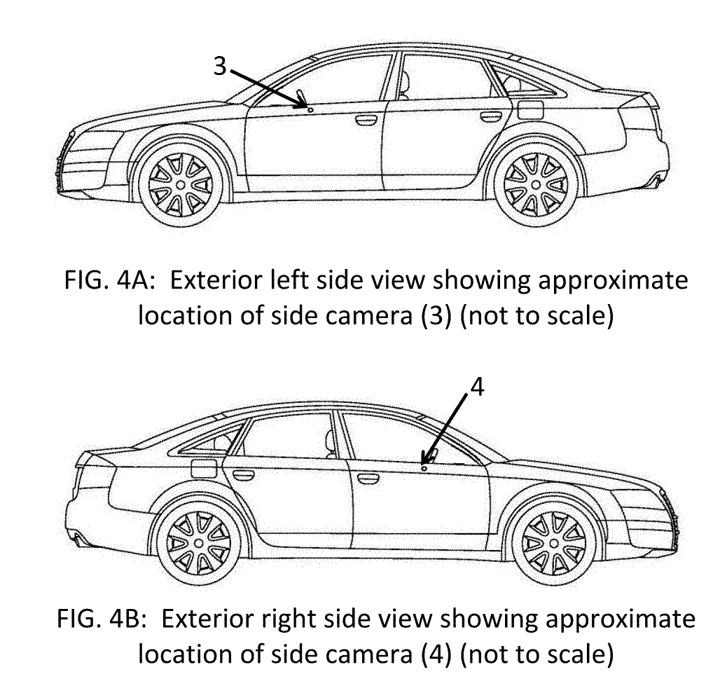

This is a line drawing showing the side views of an automobile with the approximate locations of the left side camera (3 in FIG. 4A) and right side camera (4 in FIG. 4B).

FIG. 5: Exterior rear view showing approximate location of rear camera (5) (not to scale)

This is a line drawing showing the approximate location of the rear camera (5) (not to scale)

### DETAILED DESCRIPTION OF THE INVENTION

The Digital Rear-View Mirror isn't really a mirror at all, but is designed to replace the mirrors currently in use by automobiles and trucks. Inspired by the back-up cameras that are now required in cars manufactured in the United States, the Digital Rear-View Mirror is designed to eliminate the blind spot, and to improve visibility and safety by keeping the driver's attention focused on what is ahead.

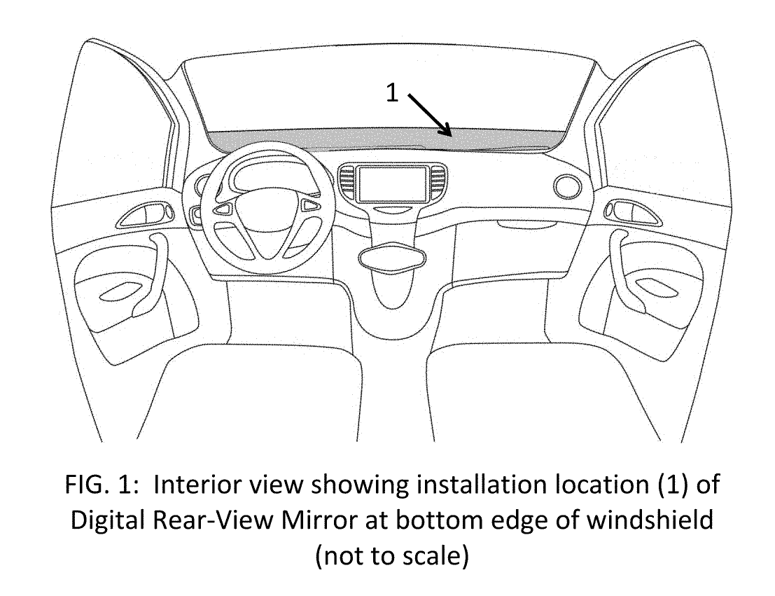

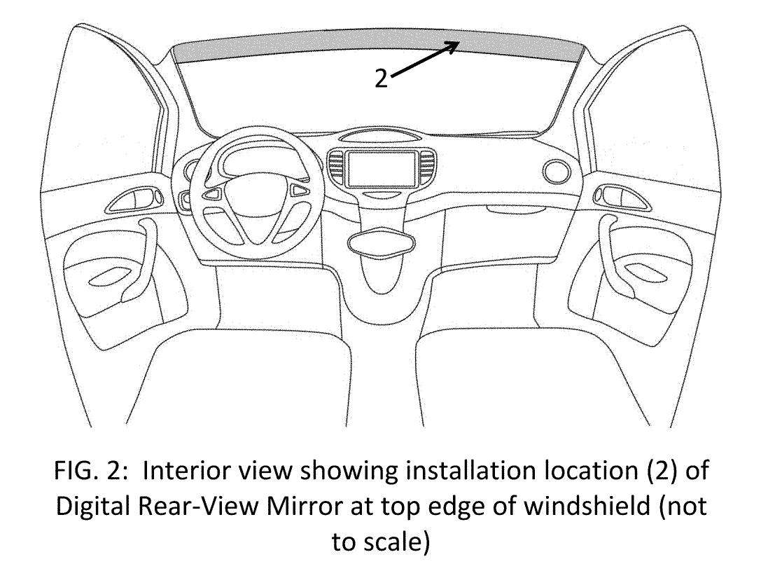

From the driver's perspective, the Digital Rear-View Mirror consists of a strip of the windshield approximately 4 inches high over the entire width of the windshield, installed either at the bottom (see 1 in FIG. 1) or the top (see 2 in FIG. 2) of the windshield. It provides a constant display of what is to the sides and behind the vehicle at all times. Its transparency is adjustable either automatically, based on the brightness of sunlight, or manually by the driver. It is on whenever the engine is running.

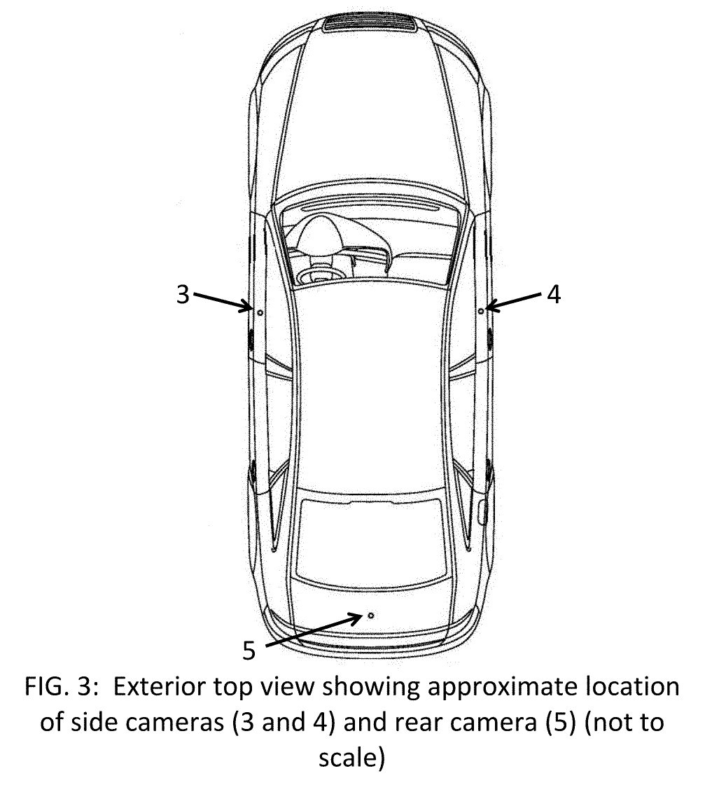

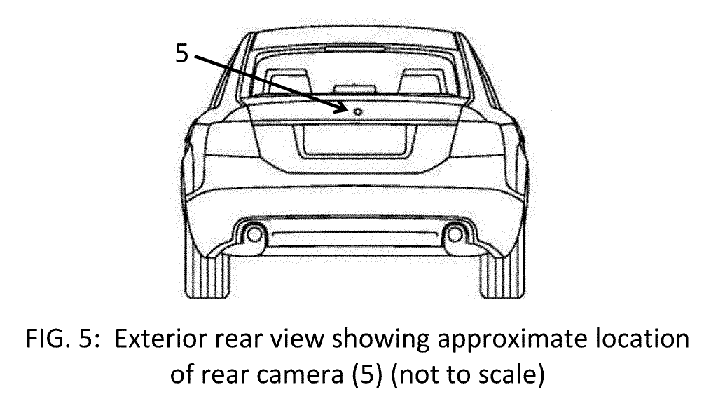

The sources of the image for the Digital Rear-View Mirror are from digital cameras located on the sides (see 3 and 4 in FIG. 3, 4A, and 4B) and rear (see 5 in FIGS. 3 and 5) of the vehicle. These cameras are recessed and shielded to protect them from damage and weather. For most passenger vehicles, two side cameras and one rear camera should be sufficient. For larger or longer vehicles, additional cameras may be needed.

1. A visual digital apparatus for use in a motor vehicle comprising:
digital cameras, at least one mounted at each of a left side, a right side and a rear of the motor vehicle; and
a digital display screen configured to display images from said digital cameras, said digital display screen installed either at a top or bottom of a front windshield of the motor vehicle covering the full width of the windshield, said digital display screen having adjustable transparency.

2. The visual digital apparatus for use in a motor vehicle as in claim 1, wherein said digital display screen integrates images from said digital cameras to provide to a driver of said motor vehicle a continuous 180-degree view from side to rear to side of the motor vehicle.

3. The visual digital apparatus of claim 2 wherein the digital display screen transparency is manually adjustable.

4. The visual digital apparatus of claim 2 wherein the digital display screen transparency is automatically adjusted in response to the brightness of sunlight.

5. The visual digital apparatus of claim 2 wherein the digital cameras are recessed and shielded.

6. A motor vehicle imaging system comprising:
a first outwardly imaging digital camera mounted on a left side of a motor vehicle;
a second outwardly imaging digital camera mounted on a rear of the motor vehicle;
a third outwardly imaging digital camera mounted on a right side of the motor vehicle; and
an adjustable transparency digital display screen spanning the full width of a bottom portion of a front windshield of said motor vehicle, configured to display images from said digital cameras.

7. The motor vehicle imaging system as in claim 6, wherein said digital display screen integrates images from each said digital camera to provide to a driver of said motor vehicle a continuous 180-degree outward view from side to rear to side of the motor vehicle.

8. The motor vehicle imaging system as in claim 7 wherein the digital display screen transparency is manually adjustable.

9. The motor vehicle imaging system as in claim 8 wherein the digital display screen transparency is automatically adjustable in response to the brightness of sunlight.

10. The motor vehicle imaging system as in claim 9 wherein the digital cameras are recessed and shielded.
